(19) United States
(12) Patent Application Publication
(10) Pub. No.: US 2011/0299604 A1
(43) Pub. Date: Dec. 8, 2011

(54) METHOD AND APPARATUS FOR ADAPTIVE VIDEO SHARPENING

(75) Inventors: Douglas Scott PRICE, San Jose, CA (US); Xiaosong ZHOU, Campbell, CA (US); Hsi-Jung WU, San Jose, CA (US); James Oliver NORMILE, Los Altos, CA (US)

(73) Assignee: APPLE INC., Cupertino, CA (US)

(21) Appl. No.: 12/895,740

(22) Filed: Sep. 30, 2010

Related U.S. Application Data
(60) Provisional application No. 61/351,645, filed on Jun. 4, 2010.

(51) Int. Cl. H04N 7/26

(52) U.S. Cl. 375/240.26; 375/E07.2

(57) ABSTRACT

A video coding system and method to adjust the sharpening procedures performed during post-processing by analyzing statistics information collected during encoding and decoding. The statistics information collected may be directed to the source of the video data, the operations executed during pre-processing and encoding of the video data, the transmission of the video data from encoder to decoder, or the operations executed during decoding. The statistics information may comprise a collection of data values, calculated statistics, or instructions for the suggested post-processing adjustments. Accumulated supplemental information may be transmitted from the encoder to the decoder via an out-of-band channel, associated with the encoded video sequence transmitted on a communications channel.

### CROSS REFERENCE TO RELATED APPLICATIONS

This application claims the benefit of priority to previously filed U.S. provisional patent application Ser. No. 61/351,645, filed Jun. 4, 2010, entitled ADAPTIVE SHARPENING FOR MOBILE VIDEO. That provisional application is hereby incorporated by reference in its entirety.

### BACKGROUND

Aspects of the present invention relate generally to the field of video processing, and more specifically to adjusting post-processing procedures using supplemental information accumulated during encoding, transmission, or decoding.

In video coding systems, a conventional encoder may code a source video sequence into a coded representation that has a smaller bit rate than does the source video and, thereby achieve data compression. The encoder may include a pre-processor to perform video processing operations on the source video sequence such as filtering or other processing operations that may improve the efficiency of the coding operations performed by the encoder.

The encoder may code processed video data according to any of a variety of different coding techniques to achieve bandwidth compression. One common technique for data compression uses predictive coding techniques (e.g., temporal/motion predictive encoding). For example, some frames in a video stream may be coded independently (I-frames) and some frames (e.g., P-frames or B-frames) may be coded using other frames as reference frames. P-frames may be coded with reference to a single previously-coded frame (P-frame) and B-frames may be coded with reference to a pair of previously-coded frames, typically a frame that occurs prior to the B-frame in display order and another frame that occurs subsequently to the B-frame in display order.

The resulting compressed sequence (bitstream) may be transmitted to a decoder via a channel. To recover the video data, the bitstream may be decompressed at the decoder, by inverting the coding processes performed by the encoder, yielding a received decoded video sequence. In some circumstances, the decoder may acknowledge received frames and report lost frames.

The quality and compression ratios achieved by the coding system may be influenced by the type of image sequences being coded. Additionally, many coding modes may be lossy processes that can induce distortion in the image data that is decoded and displayed at a receiver. Quantization, the effects of noise, the camera-capture process, unintentional or intentional pre-encoder blurring, image subsampling, interlacing and de-interlacing, and many other factors may cause distortion in the images of the video sequence. Thus, the compression and transmission processes often result in a loss of edge detail and an overall blurry received video sequence. To compensate for the induced distortion, a sharpening algorithm is often applied at the encoder or at the decoder. However, conventional sharpening algorithms, including edge enhancement, often exacerbate or even introduce undesirable mosquito noise and compression related artifacts. Accordingly, there is a need in the art for adaptive sharpening that improves the quality of the displayed video and minimizes image distortion.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram illustrating components of a video coding system according to an embodiment of the present invention.

FIG. 2 is a simplified block diagram illustrating components of an exemplary video encoder according to an embodiment of the present invention.

FIG. 3 is a simplified block diagram illustrating components of an exemplary video decoder according to an embodiment of the present invention.

FIG. 4 is a simplified block diagram illustrating components of an exemplary video coding system according to an embodiment of the present invention.

FIG. 5 is a simplified flow diagram illustrating operations at an encoder to merge accumulated statistics with encoded video data according to an embodiment of the present invention.

FIG. 6 is a simplified flow diagram illustrating operations at a decoder to utilize out-of-band information received with encoded video data according to an embodiment of the present invention.

FIG. 7 is a simplified flow diagram illustrating collecting and utilizing statistics information for a coded video sequence according to an embodiment of the present invention.

### DETAILED DESCRIPTION

An analysis of supplemental information collected by the video coding system may provide an estimation of the noise and distortion existent in an encoded video sequence. That estimate may be used to adjust the sharpening procedures performed during post-processing. Supplemental information directed to the source of the video data, the operations executed during pre-processing and encoding of the video data, the transmission of the video data from encoder to decoder, or the operations executed during decoding may be developed by the encoder or decoder throughout the video coding process. However, that information needs to be collected and evaluated to be useful during post-processing. As described herein, the supplemental information may be collected at the encoder, or the decoder, and evaluated to calculate relevant statistics, or to determine instructions for post-processing adjustments. Adjustments made to the post-processing operations based on an estimation of the noise and distortion existent throughout the video coding system may provide for adaptive filtering without inducing additional noise and artifacts.

Accumulated or evaluated supplemental information may be transmitted from the encoder to the decoder with the encoded video sequence using an out-of-band logical channel. Out-of-band channels may be defined by the predetermined coding protocol implemented by the encoder or created when the encoded video sequence is transmitted to the decoder on the communication channel. Supplemental information and statistics gathered during encoding or decoding may be used to adjust post-processing procedures. Dynamic adaptive sharpening may enhance the image displayed at the decoder without inducing or exacerbating noise or distortion in the image.

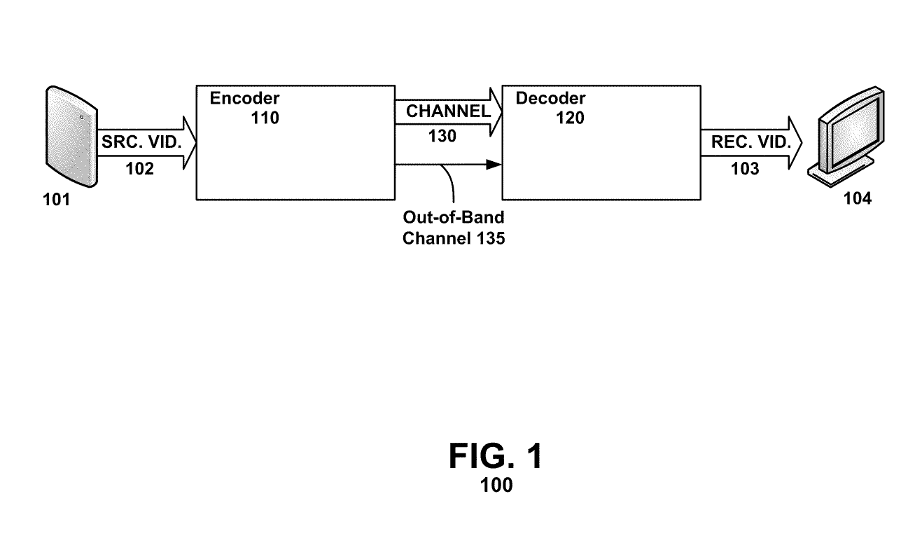

FIG. 1 is a simplified block diagram illustrating components of an exemplary video coding system according to an embodiment of the present invention. As shown, video coding system 100 may include an encoder 110 and a decoder 120. The encoder 110 may receive input source video data 102 from a video source 101, such as a camera or storage device.

Using predictive coding techniques, the encoder 110 may compress the video data with a motion-compensated prediction algorithm that reduces spatial and temporal redundancy in the video stream by exploiting spatial and temporal redundancies in the input source video sequence 102. The encoder 110 may additionally collect system statistics that may be useful in estimating noise and distortion existent in the encoded video sequence. These statistics may include camera capture statistics from the video source 101, statistics derived from the source video data 102, or statistics representing pre-processing operations conducted by the encoder 110. The resulting compressed video data may be transmitted to a decoder 120 via a channel 130 and the accumulated statistics may be transmitted to the decoder 120 via the channel 130 using an out-of-band logical channel 135 or other communicated message. The channel 130 may be a transmission medium provided by communications or computer networks, for example either a wired or wireless network and also may include storage media such as electrical, magnetic or optical storage devices.

The decoder 120 may receive the compressed video data from the channel 130 and the accumulated statistics from the out-of-band logical channel 135. The decoder 120 may then prepare the video for the display 104 by decompressing the frames of the received sequence. The processed video data 103 may be displayed on a screen or other display 104. The decoder 120 may prepare the decompressed video data for the display 104 by filtering, de-interlacing, scaling or performing other processing operations on the decompressed sequence that may improve the quality of the video displayed. The accumulated statistics may be used to control or otherwise set the parameters for the processing operations conducted at the decoder 120 to prepare the decompressed video data for the display 104.

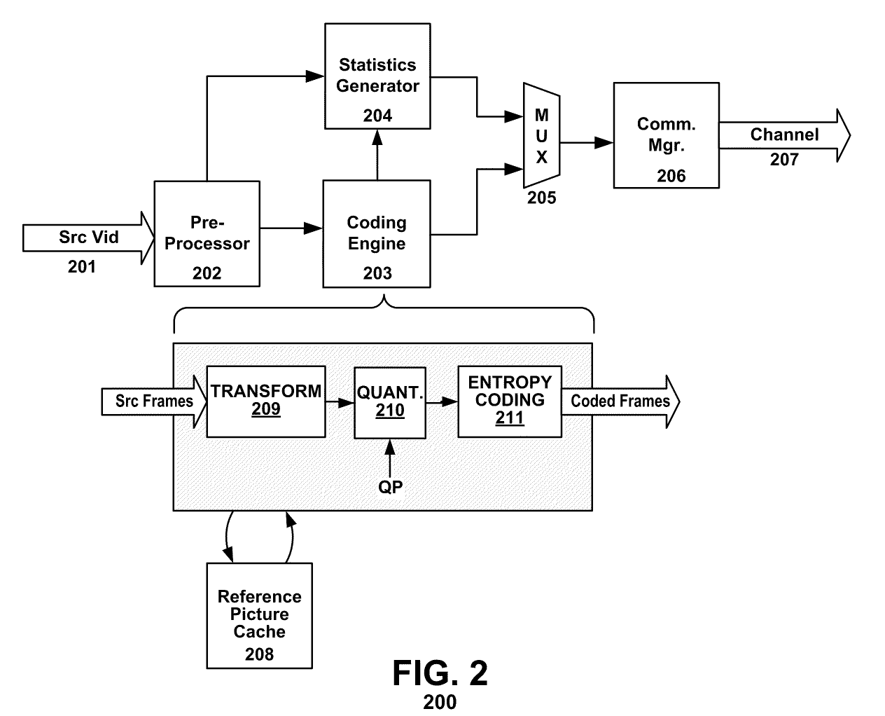

FIG. 2 is a simplified block diagram illustrating components of an exemplary video encoder 200 according to an embodiment of the present invention. As shown, encoder 200 may include a pre-processor 202, a coding engine 203, a statistics generator 204, a multiplexer (MUX) 205 and a communications manager 206. As with the coding system shown in FIG. 1, the pre-processor 202 may receive source video data 201 from a video source, such as a camera or storage device and perform pre-processing operations to prepare the source video data for coding.

The pre-processor 202 may perform video processing operations to condition the source video sequence 201 to render bandwidth compression more efficient or to preserve image quality in light of anticipated compression and decompression operations. The coding engine 203 may receive the processed video data from the pre-processor 202 and generate compressed video therefrom by performing various compression operations, including predictive coding operations that exploit temporal and spatial redundancies in the input video sequence 201. The coding engine 203 may operate according to a predetermined protocol, such as H.263, H.264, or MPEG-2 such that the encoded video sequence may conform to a syntax specified by the protocol being used.

As shown, the coding engine 203 may include a transform unit 209, a quantization unit 210, and an entropy coder 211. The transform unit 209 may convert the incoming frame or pixel block data received from the pre-processor into an array of transform coefficients, for example, by a discrete cosine transform (DCT) process or wavelet process. The transform coefficients can then be sent to the quantization unit 210 where they are divided by a quantization parameter. The quantized data may then be sent to the entropy coder 211 where it may be coded by run-value or run-length or similar coding for compression. Reference frames may be stored in reference picture cache 208 and may be used by the coding engine during compression to create P-frames or B-frames. The coded frames or pixel blocks may then be output from the coding engine 203.

The statistics generator 204 may collect information that may be useful in estimating noise and distortion existent in the encoded video sequence including camera capture statistics, statistics concerning the source video 201, statistics concerning the pre-processing operations conducted by the pre-processor 202, or statistics concerning the compression performed by the coding engine 203, including any information gathered at the transform unit 2-9, the quantization unit 210 or the entropy coder 211. Any information that the encoder 200 may have access to or generate may be collected at the statistics generator 204.

As one example of the potential accumulated statistics, quantization parameter statistics from the quantization unit 210 may be collected at the statistics generator 204. Quantization parameters (“QPs”) may be used during block-oriented coding processes by the coding engine 203 to truncate coefficient data by dividing the transformed data from the transform unit 209 by a number and retaining only the integer. Other statistics and parameters that may be informative for adjusting the sharpening procedures may include the motion estimation, the signal-to-noise ratio (SNR), or a value representing the brightness or luminance of the source video.

The statistics generator 204 may receive the relevant data from the pre-processor 202, the coding engine 203, from a source device such as a camera, or, if the video data is stored before coding, from the metadata of the stored video. The statistics generator 204 may then derive the relevant statistics or determine the relevant post-processing procedure adjustments based on the received data. For example, in an embodiment, the statistics generator 204 may collect a QP for each received frame or an average of the QP for a sequence of frames but the accumulated QP data may not be analyzed. In another embodiment, the accumulated data may be analyzed at the statistics generator 204 to determine an appropriate adjustment to the post-processing procedures. The appropriate adjustment may include changing a post-processing parameter or otherwise adjusting the post-processing operations.

After the relevant encoding statistics are accumulated at statistics generator 204, the MUX 205 may merge coded video data from the coding engine 203 with the accumulated statistics from the statistics generator 204. The accumulated statistics may then be sent in logical channels established by the governing protocol for out-of-band data.

The communications manager 206 may be a controller that coordinates the output of the merged data to the communication channel 207. In an embodiment, where the coding engine 203 may operate according to the H.264 protocol, the accumulated statistics may be transmitted in a supplemental enhancement information (SEI) channel specified by H.264. In such an embodiment, the MUX 205 may introduce the accumulated statistics in a logical channel corresponding to the SEI channel. In another embodiment, the communications manager 206 may include such accumulated statistics in a video usability information (VUI) channel of H.264.

In yet another embodiment, if the coding engine 203 may operate according to a protocol that does not specify out-of-band channels, the MUX 205 and the communications manager 206 may cooperate to establish a separate logical channel for the accumulated statistics within the output channel.

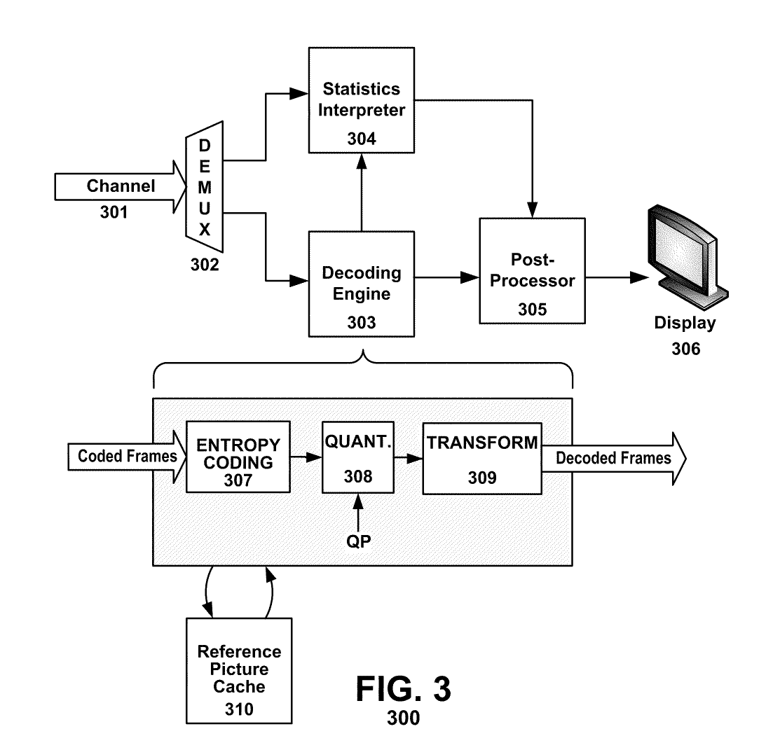

FIG. 3 is a simplified block diagram illustrating components of an exemplary video decoder 300 according to an embodiment of the present invention. Decoder 300 may include a demultiplexer (DEMUX) 302, a decoding engine 303, a statistics interpreter 304, and a post-processor 305.

The DEMUX 302 may be a controller implemented to separate the data received from the channel 301 into multiple logical channels of data thereby separating the accumulated statistics from the coded video data. As the accumulated statistics may be merged with the coded video data in numerous ways, the DEMUX 302 may be implemented to determine whether the received data uses a logical channel established by the governing protocol, the supplemental enhancement information (SEI) channel or the video usability information (VUI) channel specified by H.264 for example. Then DEMUX 302 may represent processes to separate the accumulated statistics from a logical channel corresponding to the SEI or VUI channel respectively. If the governing protocol does not specify out-of-band channels, the DEMUX 302 may cooperate with the statistics interpreter 304 to separate the accumulated statistics from the coded video data by identifying a logical channel containing out-of-band data within the channel.

After the coded video data is separated from the accumulated statistics, the coded video data may be passed to the decoding engine 303. The decoding engine 303 may then parse the coded video data to recover the original source video data, for example, by decompressing the coded video data.

As shown, the decoding engine 303 may include an entropy decoder 307, a quantization unit 308, and a transform unit 309. Thus the decoding engine 303 may reverse the processes implemented by the coding engine to recover the original source video data. The entropy coder 307 may decode the coded frames by run-value or run-length or similar coding for decompression to recover the truncated transform coefficients for each coded frame. Then the quantization unit 308 may multiply the transform coefficients by a quantization parameter to recover the coefficient values. The transform unit 309 may then convert the array of coefficients to frame or pixel block data, for example, by a discrete cosine transform (DCT) process or wavelet process. Reference frames may be stored in reference picture cache 310 and may be used by the decoding engine 303 during decompression to recover P-frames or B-frames. The decoded frames or pixel blocks may then be output from the decoding engine 303.

After the coded video data is separated from the accumulated statistics, the accumulated statistics may be passed to the statistics interpreter 304. At the statistics interpreter 304 the adjustments may be determined, if any, for the post-processing procedures to improve the video data output for display in light of the received accumulated statistics.

The post-processor 305 may receive both the decompressed video data from the decoding engine 303 and instructions for improving the video output for display from the statistics interpreter 304. The post-processor may then perform processes to condition the video data to be rendered on the display 306. The instructions from the statistics interpreter 304 may provide adjustments to the post-processing procedures to improve the quality of the video output to the display 306. For example, the type of filter used during post-processing may be changed (i.e. from low pass to band pass or from Gaussian to Block and vice versa), the size of the filter used during post-processing may be adjusted (i.e. by increasing or decreasing the number of taps activated in the filter), the strength of the filter used during post-processing may be adjusted to increase or decrease filtering (i.e. by modifying the filter parameters or increasing or decreasing the frequency band being filtered), or the adaptivity of a per-pixel filter used during post-processing may be changed (i.e. the speed with which the filter adapts to the detection of an edge may increase or decrease). Other post-processing procedures may be adjusted depending on the type of accumulated statistics received and the adjustability of the procedures themselves (i.e. the number and type of parameters that may be changed in the post-processor 305). The post-processor 305 may then perform the adjusted post-processing operations to prepare the video data for display on video display device 306.

Table 1 identifies exemplary data types for the accumulated statistics and the corresponding type of post-processing adjustment that may be implemented according to an embodiment of the present invention.

TABLE 1
Potential Post-Processing Adjustments by Data Type

| DATA TYPE | VALUE | FILTER ADJUSTMENT |
|---|---|---|
| SNR | Low | Decrease Filtering |
| SNR | High | Increase Filtering |
| QP | Low | Increase Filtering |
| QP | High | Decrease Filtering |
| Motion | Low | Increase Filtering |
| Motion | High | Decrease Filtering |
| Brightness | Low | Decrease Filtering |
| Brightness | High | Increase Filtering |
| Resolution | Low | Increase Filtering/Filter Size |
| Resolution | High | Decrease Filtering/Filter Size |

Statistics about each of the foregoing data types may be collected and analyzed by an embodiment of the coding system 100. For example, the statistics generator 204 at the encoder 200 may collect the SNR for the source video sequence. Where the SNR represents the signal-to-noise ratio of the source video sequence, each frame processed by the pre-processor 202 may have an associated SNR. Then, the encoder 200 may transmit the SNR to the decoder with the associated frame. Alternatively, the statistics generator 204 may store the SNR value for multiple frames and then calculate and transmit an average SNR, for example the average SNR for the 5 most recent frames, to the decoder 300 with the associated frame.

The decoder 300 may then receive the SNR data, either a single value or an average of multiple frames via the channel. The SNR data may then be analyzed to determine whether, and in which manner, the post-processing procedures may be adjusted to improve the quality of the image prepared for display. The analysis may be accomplished by comparing the received SNR value to predetermined thresholds to determine if the received SNR value is in a low, medium, or high range. For example, if the SNR value is above a high predetermined threshold, the SNR value of the associated frame may be considered ‘high’ and the post-processor filtering applied to the associated frame should be increased. Similarly, if the SNR value is below a low predetermined threshold, the SNR value of the associated frame may be considered ‘low’ and the post-processor filtering should be decreased. If the SNR value is between the two predetermined thresholds, the SNR value of the associated frame may be considered medium or average and the post-processor filtering applied to the associated frame may remain unchanged. Similarly, the brightness or luminance existent in the source video sequence may be calculated, collected, and analyzed.

In another embodiment, the SNR data may be analyzed by comparing the received SNR value to a stored running average of the SNR values received at the decoder 300. If the received SNR value is less than the running average, or below a predetermined range of the running average, then the received SNR value may be considered ‘low.’ Similarly, is the SNR value is greater than the running average, or above a predetermined range around the running average, then the received SNR value may be considered ‘high.’

In another embodiment, the encoder 200 may determine whether the SNR value is low, medium, or high and transmit a filtering instruction (i.e. increase, decrease, or no change) to the decoder 300 with the associated frame.

Similarly, a QP value may be collected from the coding engine 203 during quantization, and then compared to predetermined thresholds, or to a previously collected QP value, to determine if the QP for an associated frame is considered low, medium, or high. As previously noted, quantization parameters (“QPs”) may be used during block-oriented coding processes to truncate coefficient data by dividing the transformed video data by a number and retaining only the integer. Then the QP may be inversely proportional to the amount of distortion existent in the transmitted video data. For example, if the QP for a block is small, most of the spatial detail may be retained as little data may be lost when discarding the remainder from the division. As the QP is increased, additional spatial details may be lost in the discarded values, thereby decreasing the bit rate while increasing the image distortion and decreasing the image quality. Therefore the QP may be informative for setting sharpening parameters. Conventionally, there are several blocks in each frame being coded and, by extension, several QPs. In an embodiment, the statistics generator 204 may collect, for each coded frame, statistics representing the QPs used in the frame or an average of the QPs used across a sequence of frames, including the frame being coded.

Motion vectors collected from the coding engine 203 may be collected and compared to predetermined thresholds, or to a previously collected motion vectors, to determine if the motion between two frames is considered low, medium, or high. For example, during pre-processing, temporal noise may be reduced with a motion adaptive filter, the implementation of which may include calculating the average motion, or a motion estimation value, between frames. The statistics representing motion between a pair of frames or the average motion across a sequence of frames, including the frame being coded, may then be collected and analyzed.

Resolution of the transmitted coded video data may be known at the encoder 200 or the decoder 300 and may additionally be used as one variable in considering the type of post-processing adjustments that may be implemented to improve the quality of the video for display.

In an embodiment, some or all of the above identified data types may be collected by the encoder 200 at the statistics generator 204. Then the recommended post-processing adjustments may be conflicting, if for example, the SNR of a frame was considered ‘low’ but the QP of the frame was also considered ‘low.’ Then the data types might be ranked by priority, such that an adjustment responsive to a first data type (i.e. SNR) may be considered to have priority over an adjustment responsive to a second data type (i.e. QP).

In an embodiment, the encoder 200 may transmit an instruction identifying the characteristics for multiple data types. For example, for a particular combination of SNR, QP, motion, brightness, and resolution for a frame, it might be determined that to improve the quality of the image for display, the amount of filtering should be increased, the band of the filter should be decreased, the type of filter should remain consistent and the number of taps active on the filter should be increased. This particular combination of post-processing procedure adjustments may be referred to by a specific profile. Then, any time that combination of post-processing procedure adjustments is recommended, the specific profile instruction may be sent to the decoder 300 and the decoder 300 may implement the adjustments. Profiles may be defined and stored in memory prior to the initial operation of the coding system 100, or they may be derived dynamically over the course of operation of the coding system 100. In an embodiment, the decoder 300 may determine the profile based on the value of the statistics received from the encoder 200.

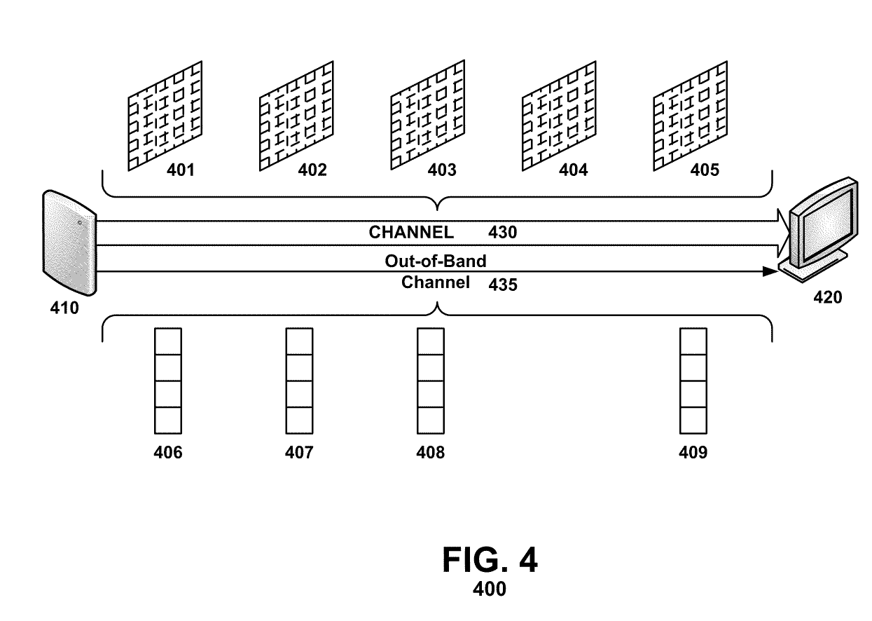

FIG. 4 is a simplified block diagram illustrating components of an exemplary video coding system 400 transmitting accumulated statistics with video data according to an embodiment of the present invention. As shown, video coding system 400 may include an encoder 410, and a decoder 420. The encoder 410 may receive an input source video data from a video source such as a camera or storage device and the decoder 420 may output processed video data to a display.

As shown, a sequence of compressed video frames 401-405 may be transmitted from the encoder 410 to the decoder 420 via a channel 430. Then, with each frame, statistics information collected at the encoder 410 may be sent from the encoder 410 to the decoder 420 via the out-of-band logical channel 435.

In an embodiment, each frame 401-405 may be transmitted with data collected when that frame was encoded. For example, the frame 401 may be transmitted with the data packet 406. The data packet 406 may contain any of the available data types for associated frame 401, for example, the QP value for the frame 401, the motion estimation for the frame 401, and the SNR for the frame 401. The decoder 420 may then analyze the information in the data packet 406 to adjust the post processing operations that may be applied to the frame 401 to prepare the frame 401 for display. Then subsequent frame 402 may be transmitted with the data packet 407 containing the QP, motion, and SNR for the frame 402.

In another embodiment, each frame 401-405 may be transmitted with post-processing instructions for that frame determined during the encoding process. For example, the frame 403 may be transmitted with the data packet 408 where the data packet 408 contains parameters for post-processing at the decoder 420. For example, the data packet 408 may contain parameters for the post-processing filters that indicate the number of taps that should be activated when filtering the frame 403, or that may otherwise adjust the strength of the post-processing filter. The decoder 420 may then implement the instructions received in the data packet 408 to adjust the post processing operations that may be applied to the frame 403 to prepare the frame 403 for display.

In another embodiment, not every frame in the sequence of frames 401-405 may be transmitted with a data packet containing collected data or post-processing instructions. For example, the frame 404 may be transmitted without a corresponding data packet. The decoder 420 may then prepare the frame 404 for display without adjusting the post processing operations that may be applied to the frame 404, for example, by maintaining the procedures as applied to a previous frame (e.g. frame 403). Then subsequent frame 405 may be transmitted with a data packet 409. The data packet 409 may contain the data collected when the frame 405 was encoded. The data packet 409 may also contain data collected from the sequence of frames 401-405, such as the average of the collected values for the sequence of frames 401-405, for example, the average QP for the sequence of frames 401-405. Or the data packet 409 may contain parameters for post-processing at the decoder 420. Then, the post processing parameters from the data packet 409 may be implemented at the decoder 420, thereby adjusting the post processing operations that may be applied to each subsequent received frame until new instructions are received in a subsequent data packet.

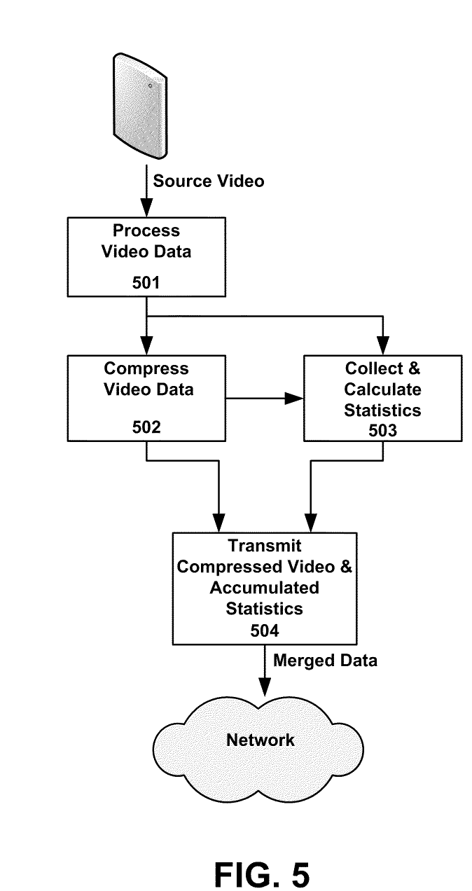

FIG. 5 is a simplified flow diagram illustrating operating an encoder to merge accumulated statistics with encoded video data according to an embodiment of the present invention. At block 501, various preprocessing operations may be performed on the received source video data to prepare the video data for encoding. The pre-processing may include filtering or other operations to improve efficiency of coding operations or to preserve image quality during the encoding and decoding process. Then, at block 502, the processed video data may be coded in accordance with standard encoding techniques to achieve bandwidth compression.

At block 503, the type(s) of supplemental information that may be useful to optimize post-processing operations may be determined, and statistics concerning that supplemental information may be calculated. Information collected from the source video data or the source device, or generated during pre-processing or video compression may be collected to calculate relevant statistics. As previously noted, more than one type of supplemental information may be considered significant for optimizing the post-processing operations and collected to calculate the relevant statistics.

The type(s) of supplemental information from which relevant statistics may be calculated, may be determined by the limitations of the encoding or decoding system. The priority of data types may be predetermined or may be dynamically determined during statistics accumulation. For example, if the supplemental information that may be calculated during encoding may be variable, and it may be determined that the source video contains frames with significant motion resulting in a high motion average, the motion estimation may be considered significant for optimizing the post-processing operations. However, if the motion average is low, but the source video has a fluctuating QP, then the QP may be considered significant for optimizing post-processing.

Alternatively, if the supplemental information that may be collected during encoding may be variable, but it may be known that the post-processing filtering cannot be altered or only a certain aspect of post-processing may be altered, then certain statistics that may be useful for determining an optimal value for the particular post-processing filtering parameters that are fixed may be of limited use, may not be considered significant for optimizing post-processing, and may not be collected as part of the supplemental information. If, however, the type of supplemental information that may be calculated during encoding is not variable, the type(s) of statistics collected may be limited to particular predetermined data types.

At block 504, the accumulated statistics and the coded video data may then be combined to utilize an out-of-band channel for transmission of the accumulated statistics to a video receiver. The utilized out-of-band channel may be a channel specified for out-of-band data by the predetermined protocol used to code the video data during compression. Alternatively, if the protocol used to code the video data does not specify out-of-band channels, a separate logical channel may be created to output the accumulated statistics with the coded video data.

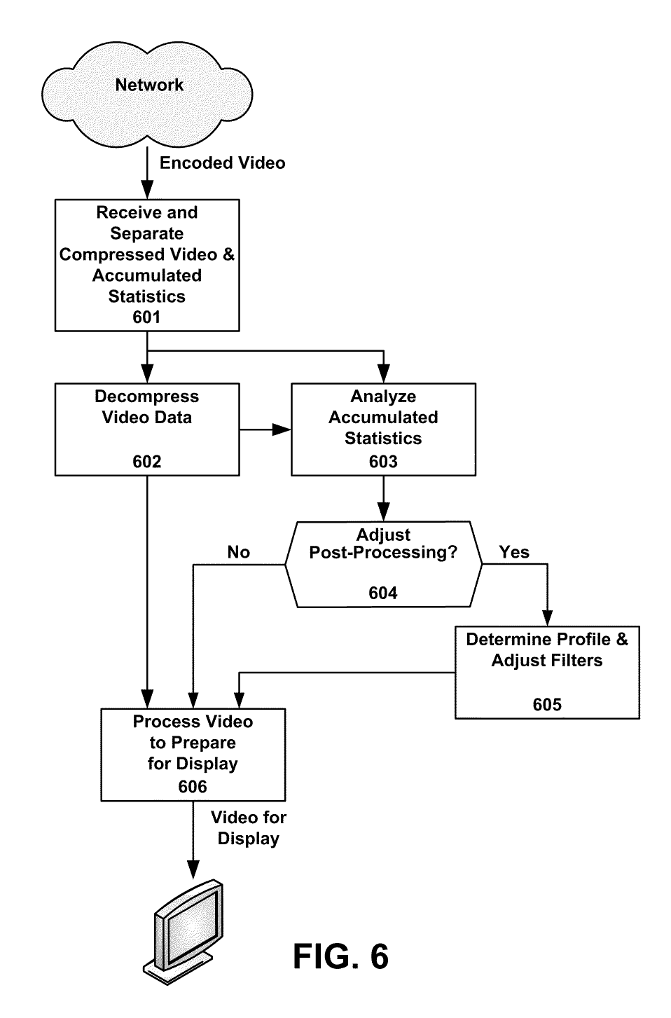

FIG. 6 is a simplified flow diagram illustrating operating a decoder to utilize out-of-band information received with encoded video data according to an embodiment of the present invention. Initially, encoded video data may be received and separated at block 601. The encoded video data may include both channel data containing the coded and compressed source video data, and out-of-band data containing statistic information accumulated at the encoder and received on a logical channel. Then, the coded and compressed source video data may be decompressed and decoded at block 602 to recover the original source data.

The accumulated statistics may then be analyzed at block 603 to determine if any post-processing procedure should be adjusted to improve the video output for display. In an embodiment, the accumulated statistics may comprise a collection of data to be analyzed in order to determine the impact of the data on the post-processing operations. For example, the accumulated statistics may include a QP for each received frame or an average of the QP for a sequence of frames. Then, the analysis at block 603 may include comparing the received QP data to predetermined thresholds to determined if the QP data falls within a low, average, or high range. In another embodiment, the accumulated statistics may include specific post-processing instructions or parameters. For example, the accumulated statistics may include instructions to increase the filtering of the post-processing procedures. Then, the analysis at block 603 may include determining whether the instructions can be implemented or how best to implement the adjustment. Alternatively, the accumulated statistics may indicate that the transmitted video data conforms to a specific predefined profile. Then the analysis at block 603 may include determining whether the indicated profile warrants a post-processing procedure adjustment. Additionally, information collected during the separation and decompression processes (transmission details or data losses for example) may be used to adjust the post-processing procedures.

If, at block 604, it is determined that no post-processing procedure adjustment is warranted, then the decompressed video data may be prepared for display at block 606. If at block 604 it is determined that the post-processing procedures should be adjusted, the type of adjustment is determined and implemented at block 605.

Post-processing procedure adjustments may include altering the post-processing filtering by changing the type of filter (from a low pass filter to a band pass filter or from a Gaussian filter to a Block filter for example), by increasing or decreasing the number of taps activated in the filter, by modifying the filter parameters, by increasing or decreasing the frequency band being filtered, or by increasing or decreasing the speed with which the filter adapts to the detection of an edge. Then the decompressed video data may be prepared for display at block 606 using the adjusted post-processing procedures.

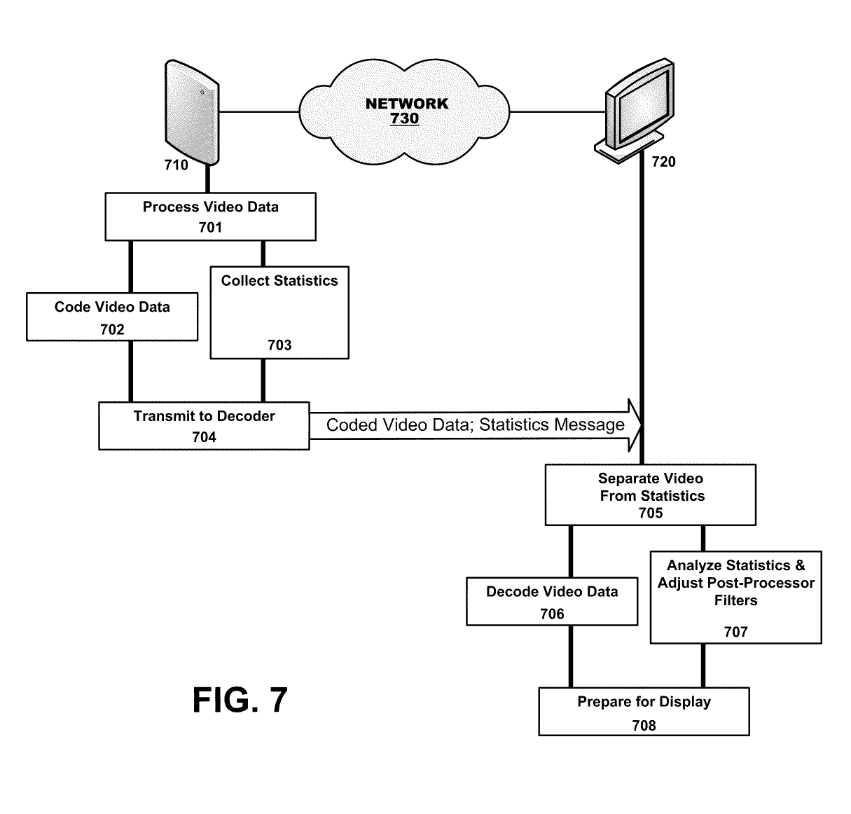

FIG. 7 is a simplified flow diagram illustrating collecting and utilizing statistics information for a coded video sequence according to an embodiment of the present invention. At block 701, video data may be processed at the encoder 710 to condition the source video sequence to render bandwidth compression more efficient or to preserve image quality in light of anticipated compression and decompression operations. As previously noted, a pre-processor at the encoder 710 may separate received video data into frames. The frames may then be coded and compressed at block 702. The encoder 710 may additionally collect system statistics at block 703 that may be useful in estimating noise and distortion existent in the encoded video sequence. These statistics may include camera capture statistics from the video source, statistics derived from the source video data, or statistics representing pre-processing or video coding operations conducted by the encoder. At block 704, the coded video data and the statistics information may be prepared and transmitted to the decoder 720 via the network or channel 730 such that the accumulated statistics message may be sent in a logical channel established for out-of-band data such as an SEI channel of an H.264 communications channel.

The decoder 720 may receive the coded video data and the statistics information from the channel 730 and may then separate the accumulated statistics from the coded video data at block 705. Then the coded video data may be decoded and decompressed at block 706 to recover the original source video data. After the coded video data is separated from the accumulated statistics, the accumulated statistics may be analyzed or interpreted at block 707. The analysis may include determining if any post-processing procedures or filters may be adjusted to improve the video data output for display. Then the decompressed video data may be prepared for display at block 708 according to the adjusted post-processing procedures.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 2 illustrates the components of the encoder 200, including the statistics generator 204, the MUX 205, and the communications manager 206 as separate units, in one or more embodiments, some or all of them may be integrated and they need not be separate units. Such implementation details are immaterial to the operation of the present invention unless otherwise noted above. Additionally, it is noted that the arrangement of the blocks in FIGS. 5 and 6 do not necessarily imply a particular order or sequence of events, nor are they intended to exclude other possibilities. For example, the operations depicted at blocks 502 and 503 or at blocks 602 and 603 may occur substantially simultaneously with each other.

While the invention has been described in detail above with reference to some embodiments, variations within the scope and spirit of the invention will be apparent to those of ordinary skill in the art. Thus, the invention should be considered as limited only by the scope of the appended claims.

What is claimed is:

1. A video encoding system comprising:
a pre-processor operable to perform processing operations on an input video sequence,
a coding engine operable to perform bandwidth compression coding operations on a video sequence from the pre-processor;
a statistics generator operable to compile statistics information on frames of the video sequence being coded; and
a transmission unit operable to transmit coded video data from the coding engine and compiled statistics information to a decoder, the coded video data transmitted according to a coding syntax of a predetermined video standard and the statistics data is transmitted according to an out-of-band channel.

2. The system of claim 1, wherein the statistics represent characteristics of the input video sequence as obtained by an image capture device.

3. The system of claim 1, wherein the statistics represent characteristics of the input video sequence as derived by the pre-processor.

4. The system of claim 1, wherein the statistics represent characteristics of coding parameters applied by the coding engine.

5. The system of claim 1, wherein the out-of-band channel is a Supplemental Enhancement Information (SEI) message of a video compression standard.

6. The system of claim 1, wherein the out-of-band channel is a transmission channel between the encoding system and the decoder separate from a transmission channel used to transmit the coded video data from the encoding system to the decoder.

7. The system of claim 1, wherein the statistics information comprises a calculated average of statistics for a plurality of frames.

8. The system of claim 1, wherein the statistics information comprises a motion estimation.

9. The system of claim 1, wherein the statistics information comprises a signal-to-noise ratio.

10. The system of claim 1, wherein the statistics information comprises a quantization parameter.

11. The system of claim 1, wherein the statistics information comprises a resolution of the input video sequence.

12. The system of claim 1, wherein the statistics information comprises a luminance value.

13. The system of claim 1, wherein the statistics information comprises a profile representing a combination of information types.

14. A video encoding system comprising:
a pre-processor operable to perform processing operations on an input video sequence,
a coding engine operable to perform bandwidth compression coding operations on a video sequence from the pre-processor;
a statistics generator operable to derive statistics information of the input video sequence from the video sequence; and
a transmission unit operable to transmit coded video data from the coding engine and compiled statistics information to a decoder.

15. The system of claim 14, wherein the statistics represent characteristics of the input video sequence as generated by an image capture device.

16. The system of claim 14, wherein the statistics represent characteristics of the input video sequence as derived by the pre-processor.

17. The system of claim 14 wherein the out-of-band channel is a Supplemental Enhancement Information (SEI) message of a video compression standard.

18. The system of claim 14 wherein the out-of-band channel is a transmission channel between the encoding system and the decoder separate from a transmission channel used to transmit the coded video data from the encoding system to the decoder.

19. The system of claim 14 wherein the statistics information comprises a calculated average of statistics for a plurality of frames.

20. The system of claim 14 wherein the statistics information comprises a motion estimation.

21. The system of claim 14 wherein the statistics information comprises a signal-to-noise ratio.

22. The system of claim 14 wherein the statistics information comprises a resolution of the input video sequence.

23. The system of claim 14 wherein the statistics information comprises a luminance value.

24. The system of claim 14 wherein the statistics information comprises a profile representing a combination of information types.

25. A video decoding system comprising:
a controller operable to separate statistics information and an encoded video sequence from a received video signal;
a decoding engine operable to perform bandwidth decompression decoding operations on the encoded video sequence;
a statistics interpreter operable to analyze the statistics information and to determine a process adjustment; and
a post-processor operable to perform a post-processing operation according to the determined process adjustment.

26. The system of claim 25 wherein the statistics interpreter module collects additional statistics information representing characteristics of the video decoding system.

27. The system of claim 25 wherein the statistics information comprises an instruction that describes the process adjustment.

28. The system of claim 25 wherein the post-processor further comprises a filter.

29. The system of claim 28 wherein said determined process adjustment changes said filter's type.

30. The system of claim 28 wherein said determined process adjustment changes said filter's size.

31. The system of claim 28 wherein said determined process adjustment changes said filter's strength.

32. The system of claim 28 wherein said determined process adjustment changes said filter's adaptivity.

33. A method of coding video data comprising:
coding an input video sequence;
collecting statistics information for frames of the input video sequence; and
transmitting the statistics information value with the coded video sequence on a communication channel;
wherein said transmitting comprises transmitting the statistics information according to an out-of-band channel.

34. The system of claim 33, wherein the statistics represent characteristics of the input video sequence collected from an image capture device.

35. The system of claim 33, wherein the statistics represent characteristics of the input video sequence collected during a pre-processing operation.

36. The system of claim 33, wherein the statistics represent characteristics of coding parameters collected during the coding of the input video sequence.

37. The system of claim 33, wherein the out-of-band channel is a Supplemental Enhancement Information (SEI) message of a video compression standard.

38. The system of claim 33, wherein the out-of-band channel is a transmission channel between the encoding system and the decoder separate from a transmission channel used to transmit the coded video data from the encoding system to the decoder.

39. The system of claim 33, wherein the statistics information comprises a calculated average of statistics for a plurality of frames.

40. A method of decoding video data comprising:
separating an encoded video sequence and statistics information from a received video signal;
decoding the encoded video sequence;
analyzing the statistics information to determine a post-processing adjustment;
adjusting a post-processing procedure based on the determined post-processing adjustment; and
preparing the decoded video sequence for display by performing the adjusted post-processing procedure.

41. The method of claim 40 wherein said preparing further comprises filtering the decoded video sequence.

42. The method of claim 41 wherein said adjusting further comprises adjusting a parameter for said filtering.

43. The method of claim 40 wherein said adjusting further comprises collecting a second statistic descriptive of said decoding and adjusting said post-processing procedure based on the second statistic.
